(19) United States
(12) Patent Application Publication
(10) Pub. No.: US 2024/0375013 A1
(43) Pub. Date: Nov. 14, 2024

(54) COMPUTER-IMPLEMENTED METHOD AND SYSTEM

(71) Applicant: Sony Interactive Entertainment Europe Limited, London (GB)

(72) Inventor: Christopher William HENDERSON, London (GB)

(73) Assignee: Sony Interactive Entertainment Europe Limited, London (GB)

(21) Appl. No.: 18/659,146

(22) Filed: May 9, 2024

(30) Foreign Application Priority Data
May 9, 2023 (GB) 2306832.3

(51) Int. Cl. A63F 13/67

(52) U.S. Cl. CPC A63F 13/67

(57) ABSTRACT

A method and system is provided which trains a neural network which can be used to provide a player presence in a computer generated gaming environment.

### CROSS-REFERENCE TO RELATED APPLICATIONS

The present application claims priority from British Patent Application No. 2306832.3 filed May 9, 2023, the contents of which are incorporated herein by reference in its entirety.

### FIELD

The invention relates to a method and system. Particularly, but not exclusively, the invention relates to a computer implemented method and system. Further particularly, but not exclusively, the invention relates to a computer implemented method and system which enables a user presence to be provided inside a computer-generated interactive entertainment environment.

### BACKGROUND

Computer games are often played by more than a single person and often in larger groups playing together with the aid of the internet and the processing capacity provided by the cloud. Multi-player gaming provides a lot of enjoyment but also provides a feeling of competition among those players, whether they know each other or not.

However, it is not always possible to play against the players of preference, or against anyone at all. Often computer games have a single player mode where an individual can play against the computer. However, some gamers have a preference for multiplayer modes which can result in the perception of a limited experience in single player modes.

Aspects and embodiments are conceived with the foregoing in mind.

### SUMMARY

Aspects relate to providing a player presence in a computer generated gaming environment. A player presence may for example be a character which is controlled by the player or a non-player character which is not controlled by the player. A computer generated gaming environment may be provided on a computing device during game play in a computer game. A computer game may comprise a plurality of game states. Each game state may provide a plurality of visual, audio and tactile cues to a player who is playing the game in the computer generated gaming environment.

Viewed from a first aspect, there is provided a computer-implemented method of providing a first player presence in a computer generated gaming environment. The first player presence may be a non-player character. The first player presence may be a character provided in the gaming environment which is controlled using a neural network in that the neural network controls how the first player presence responds to game states. The method may be implemented by a processing resource. A processing resource may be implemented using a cloud-implemented computing resource or using a local computing resource. A processing resource may be any resource which can provide computer processing capability. The method may comprise obtaining game play data associated with a second player presence in the computer generated gaming environment. The second player presence may be a user who is playing a game in the computer generated gaming environment. Obtaining game play data may be implemented by determining that a user is playing a computer game in the computer generating gaming environment and is entering inputs to respond to the game states which are provided as part of the game in the computer generated gaming environment and then determining what those inputs are. The inputs which the user uses to respond to a game state may be described as a response action which comprises at least one input which are received from a computing device to be interpreted and/or rendered in the computer generated gaming environment. The method may further comprise using the game play data associated with the second player presence to train a neural network associated with the second player presence. The training may comprise using the game play data to train the neural network associated with the second player presence. For example, where the second player presence corresponds to a player who has played the game being played in the computer generated gaming environment the training may be based on how the player responds to the game states which are encountered in the computer generated gaming environment. The training of the neural network may be implemented using techniques of supervised, unsupervised or reinforcement learning. The neural network may be an artificial neural network (ANN). ANNs are otherwise known as connectionist systems which are computing systems which are vaguely inspired by biological neural networks. Such systems “learn” tasks by considering examples, generally without task-specific programming. They do this without any prior knowledge about the task or tasks, and instead, they evolve their own set of relevant characteristics from the learning/training material that they process. ANNs are considered nonlinear statistical data modelling tools where the complex relationship between inputs and outputs are modelled or patterns are found.

ANN may be hardware (where neurons are represented by physical components) or software-based (computer models) and can use a variety of topologies and learning algorithms.

ANNs usually have three layers that are interconnected. The first layer consists of input neurons. Those neurons send data onto the second layer, referred to as a hidden layer which implements a function and which in turn sends the output neurons to the third layer. There may be a plurality of hidden layers in the ANN. With respect to the number of neurons in the input layer, this parameter is based on training data.

The second or hidden layer in a neural network implements one or more functions. For example, the function or functions may each computer a linear transformation or a classification of the previous layer or compute logical functions. For instance, considering that the input vector can be represented as x, the hidden layer functions as h and the output as y, then the ANN may be understood as implementing a function f using the second or hidden layer that maps from x to h and another function g that maps from h to y. So the hidden layer's activation is f(x) and the output of the network is g(f(x)).

The input layer may receive game play data which may comprise an indication of a game state (i.e. an identifier or a vector of data items representing the game state). The hidden layer may comprise a policy function which is optimised to predict a response which would be provided by the first user presence. The output layer may provide the response which is predicted by a policy function.

The method may comprise providing the first player presence by determining a requirement for the first player presence and generating the first player presence using the neural network associated with the second player presence.

The first player presence may be provided autonomously or responsive to a request from a user. The neural network may be initialised autonomously. The neural network may be trained autonomously when gameplay data associated with the second user presence has been obtained.

The steps of the method may be carried out in real time or at separate times.

A method in accordance with the first aspect may provide a first player presence using a neural network which is trained on the gameplay data of a second user presence. The first player presence can be provided in the computer generated gaming environment where a game is being player. The first player presence can therefore be provided as a simulated version of the second player presence which responds to individual game states as a player in accordance with the first player presence would be expected to based on the training of the neural network. The neural network may receive a game state as an input and generate an output based on how a player in accordance with the second player presence would response to that game state.

A computer generated gaming environment may mean a virtual or augmented reality environment which is provided through one or more computing devices where a computer game is to be rendered and inputs into that computer game are to be implemented and/or rendered.

Optionally, the neural network associated with the second player presence may be trained using reinforcement learning. That is to say, the neural network may be trained to configure an intelligent agent to respond to a game state without the need for labelled input/output pairs to be presented. The reinforcement learning may be used to optimise a policy function configured to generate responses expected from the second player presence. The learning may take place by determining that a player playing a game inside a computer generated gaming environment is statistically likely to respond to a game state using a specific response action. This may be determined over a plurality of iterations of training which match the game state to a specific respond using multiple iterations.

Game play scenario characteristics may be used to train the neural network. Game play scenario characteristics may relate to non-game specific characteristics such as threat level, adventure, etc to determine how a player in accordance with the second player presence responds to, say a game state which provides a threat. The technical effect is that the neural network becomes applicable across games in that it is trained to predict how the second user presence responds to threat events, for example, rather than specific game states.

The first player presence may be a non-player character and the second player presence represents at least one user who controls or has previously controlled a character in the computer generated gaming environment. The technical effect of this is that a non-layer character can be trained based on how players play the game. This may be used to adapt or evolve the non-player characters based on the players who have played the game.

The first player presence may be provided responsive to a user encountering a first game state and the first player presence may be provided responsive to a request from a user with an active presence in the computer generated gaming environment The request may be made through an appropriately configured user interface on a computing device. An active presence may be taken to mean a user who is playing the game.

The second player presence may correspond to at least one user of the computer generated gaming environment. The effect of this is that the neural network may be trained based on an individual who has played inside the computer generated gaming environment. The user may be selected using a user interface which presents a list of users or user groups.

The second player presence may correspond to a group of users of the computer generated gaming environment. The training of the neural network may be iterated across all members of the group of users to generate a neural network which represents the group of users as a second user presence and therefore enable first player presence to be provided which is based on that group of users. The group may be autonomously identified by the processing resource or it may be identified by a user.

The group of users, for example, may be unified by a demographic characteristic. Such a demographic characteristic may be a nationality, a religion, a gender or another identifier which identifies a person based on where they sit in the demography of the planets population. #

The group of users may be unified by a competence level in the computer generated gaming environment. That is to say, the neural network may be trained based on users who are, for example, novices or experts.

The training of the neural network may be repeated at specified intervals. The specified intervals may be specified by an operative of the processing resource in terms of months, years or days. The repetition of the training of the neural network may be initialised autonomously.

The training may be repeated for all game states which can be provided in the computer generated gaming environment.

### DESCRIPTION

A first embodiment will now be described by way of example only and with reference to the following drawings in which:

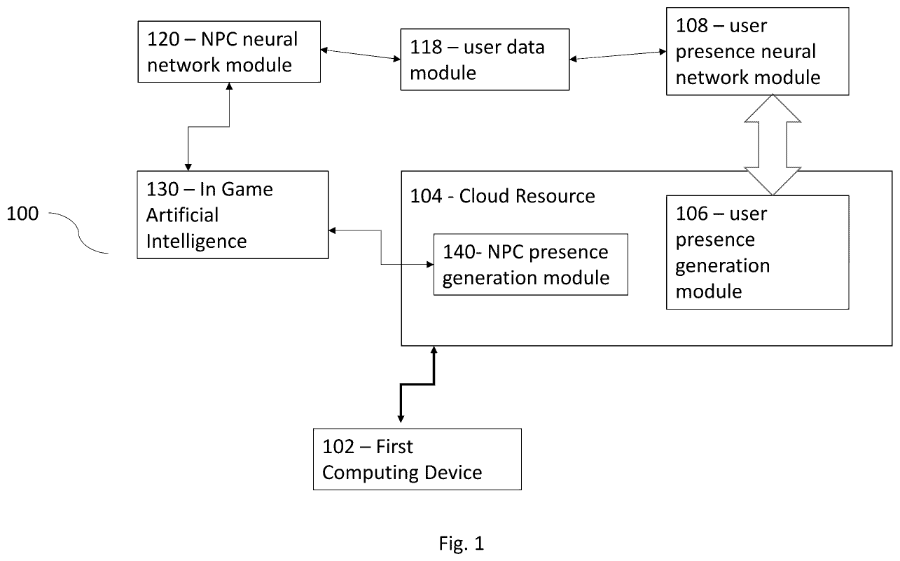

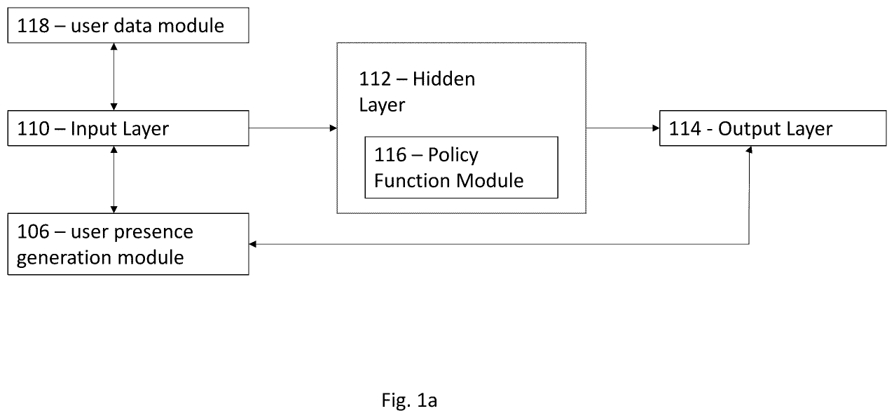

FIG. 1 provides a schematic illustration of an architecture in accordance with the embodiment;

FIG. 1a provides a schematic illustration of a neural network which can be used to implement a player presence in accordance with the embodiment;

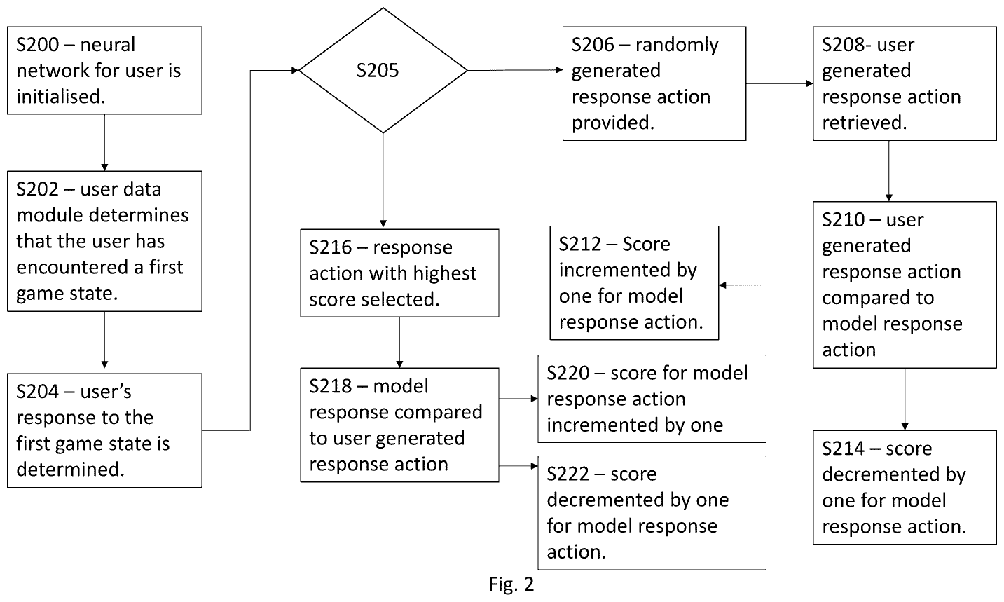

FIG. 2 schematically illustrates how a neural network associated with a user of the computer generated gaming environment may be provided in accordance with the embodiment;

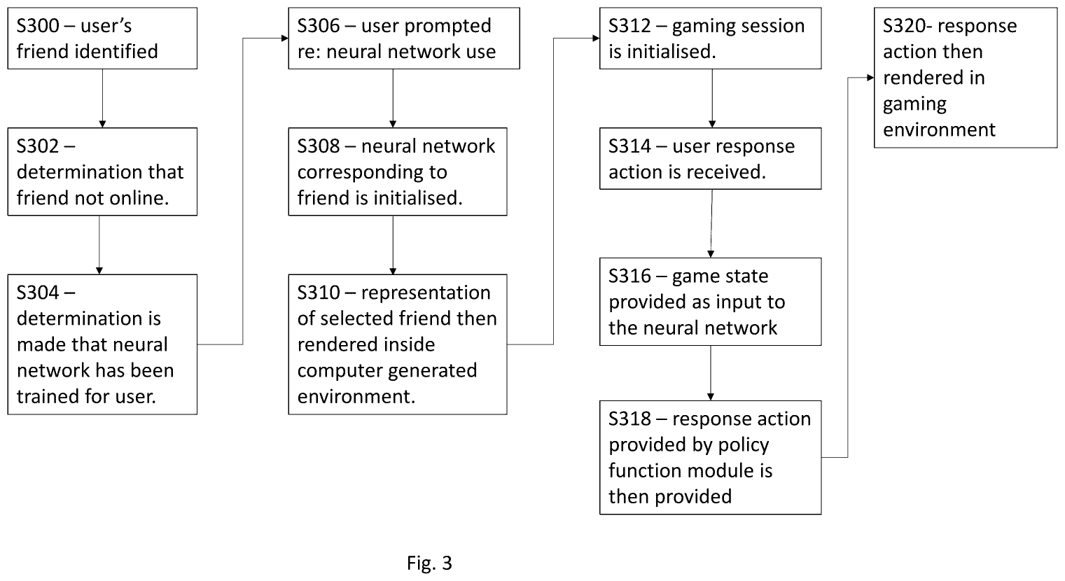

FIG. 3 schematically illustrates how a neural network may be used to simulate a user presence in the computer generated gaming environment in accordance with the embodiment;

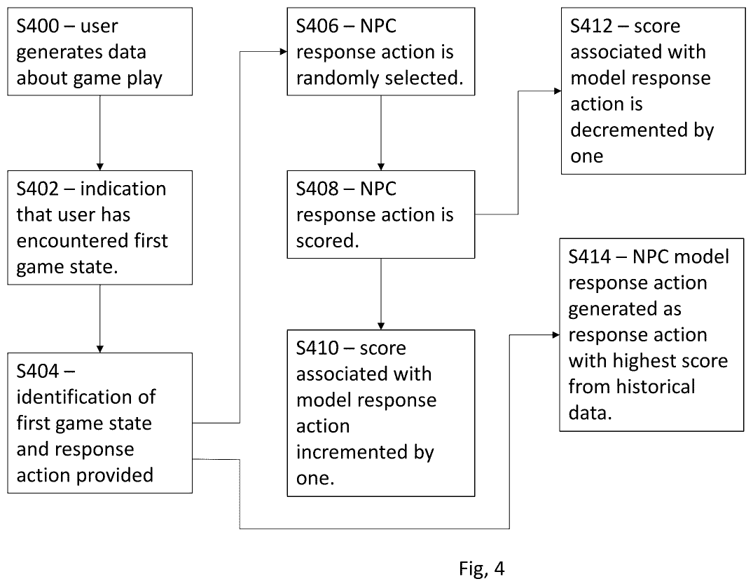

FIG. 4 schematically illustrates how a neural network may be trained to implement a non-player character in accordance with the embodiment;

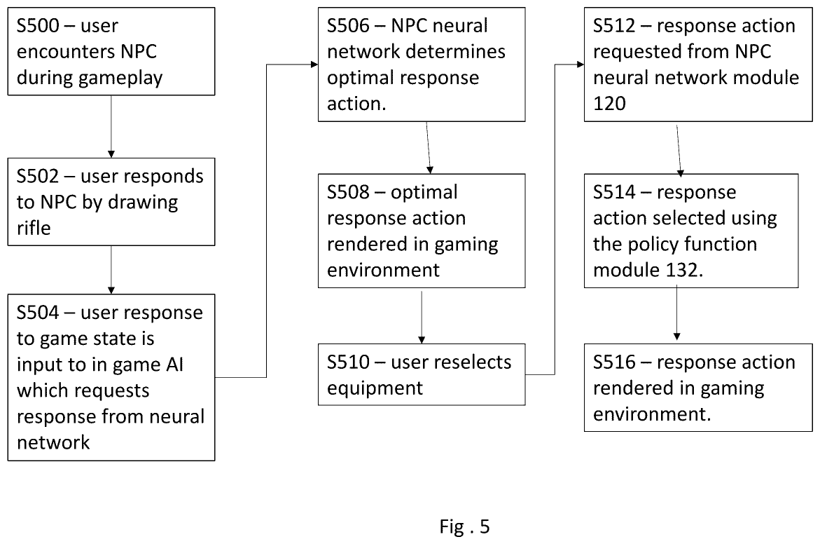

FIG. 5 illustrates how a non-player character can be implemented inside a computer generated gaming environment in accordance with the embodiment;

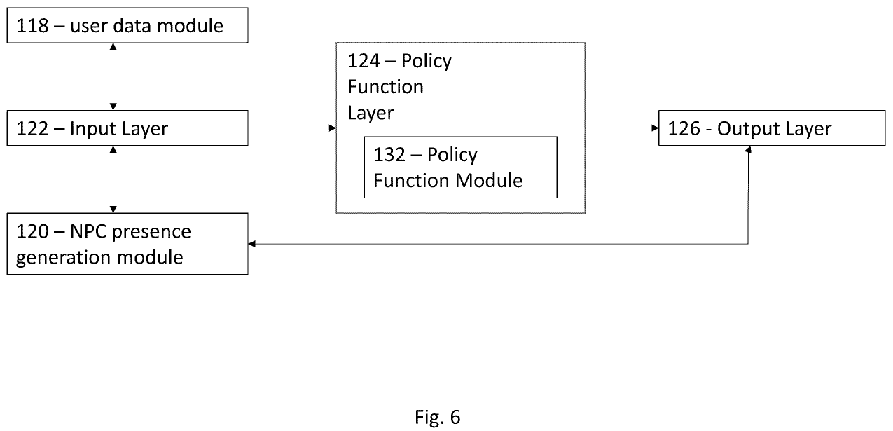

FIG. 6 illustrates how a neural network can be configured to provide a non-player character in accordance with the embodiment; and

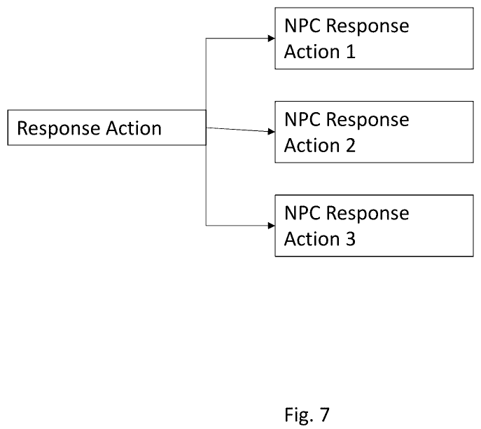

FIG. 7 illustrates how a response action can lead to response actions from a non-player character in accordance with the embodiment.

We will now describe, with reference to FIG. 1, an architecture 100 which may be used to implement a system in accordance with an embodiment.

The architecture 100 comprises a first computing device 102 configured to interact with cloud resource 104 to implement a computer generated gaming environment on the first computing device 102. That is to say, the first computing device 102 provides an interface with a computer generated gaming environment provided by the cloud resource 104 in that commands from the user which need to be interpreted in the computer generated gaming environment are received through the first computing device 102, transmitted to the cloud resource 104 and processed by the cloud resource 104 before the command is implemented inside the computer generated gaming environment by cloud resource 104. For example, this may be a command to move a character inside the computer generated gaming environment which requires a button press on first computing device 102 to implement the movement of that character inside the computer generated gaming environment by rendering that movement in a way in which it can be visualised on the first computing device 102.

The first computing device 102 may be a mobile telephone or any other device capable of providing an interface to a computer generated gaming environment. The first computing device 102 may be augmented reality or virtual reality headset which can enable access to a computer generated gaming environment which is provided using augmented reality or virtual reality techniques.

A command from the user may be in the form of a series or sequence of button presses or other inputs into a user interface. These may be input from a controller which is part of the first computing device 102 either as an integral part of the first computing device 102 or a peripheral device to the first computing device 102. The command may be input by the user who may want a character in the computer generated gaming environment to perform a specific action or series of actions which is then rendered by the cloud resource 104 inside the computer generated gaming environment.

The first computing device 102 may be one of a plurality of computing devices which are all similarly interacting with the cloud resource 104 as part of a multiplayer gaming environment which is provided by the cloud resource 104 during game by a user of the first computing device 102.

Some of the processing which is necessary to provide the computer-generated gaming environment on a computing device may be executed on the first computing device 102 or one of the other computing devices instead of the cloud resource 104.

The cloud resource 104 is used in the example we describe but any suitable processing resource could be used.

The interaction between the first computing device 102 (or any of the other computing devices) and the cloud resource 104 is enabled using any suitable telecommunications network.

The cloud resource 104 comprises a user presence generation module 106 which is configured to provide input to a user presence neural network module 108 and to receive output from the user presence neural network module 108. This interaction is enabled using any suitable telecommunications network. The output can then be implemented and/or rendered inside the computer generated gaming environment provided by the cloud resource 104.

The architecture also comprises an in-game artificial intelligence which is configured to implement non-player characters in the computer generated gaming environment provided by the cloud resource 104.

The architecture also comprises an NPC presence generation module 140 which is configured to render non-player characters in the computer generated gaming environment.

The architecture also comprises an NPC neural network module which is configured to generate response actions for an NPC which is implemented by the in-game artificial intelligence.

We will now describe how a neural network implemented by the user presence neural network module 108 is trained using reinforcement learning to generate a user presence inside the computer implemented gaming environment which is then rendered by the cloud resource 104.

In a step S200, a neural network for a user is initialised by the user presence neural network module 108. The initialisation of the neural network means that all necessary hardware and software resources for the neural network for the user are allocated.

The user is a person who has played the computer game which is provided by the computer generated gaming environment. The user may be identified by a user of the first computing device 102 and will form a user group on their own. Additionally or alternatively, the user may be part of a larger user group. Such a larger user group may be everybody that has ever played the game inside the computer generated gaming environment. Such a larger user group may be characterised in another way. It may be all users who are characterised as a novice, for example, or all users who are characterised as being an expert. This characterisation may be characterised by a user data module 118 which monitors the game play inside the computer generated gaming environment to determine the activity associated with the user inside the game. The user may be the user of the first computing device 102 or an individual on a list of players who regularly play the game in a multi-player gaming environment with the user of the first computing device 102.

The neural network implemented by the user presence neural network module 108 comprises an input layer 110, a hidden layer 112 and the output layer 114, as schematically illustrated in FIG. 1a. The hidden layer 112 comprises a policy function module 116 which is configured to provide a predicted action which would be taken by a user in response to encountering a game state of a game in the computer generated gaming environment. The input layer 110 is configured to receive data from the user data module 118 and the user presence generation module 106, which will be described in more detail below. The output layer 114 is configured to provide an output from the neural network as determined by the policy function module 116 and this output is provided to the user presence generation module 106 to enable it to be rendered inside the computer generated gaming environment by the cloud resource 104.

In a step S202, the user data module 118 is configured to determine that the selected user (i.e. the user who will be associated with the initialised neural network) has encountered a first state game state (s1) inside a game which is being played by the user in the computer generated gaming environment provided by the cloud resource. The user data module 118 may be located separately to or as part of the cloud resource 104 or the user presence generation module 106 or the user presence neural network module 108. In an example of a shooter game, the user encountering a first game state may be the user encountering a specific enemy or in a motor racing game this may be the user encountering a bend on a race track.

In a step S204, it is determined that the user has provided a response action to this game state which comprises a series of inputs to their computing device to implement an action (a1) inside the gaming environment to move from the first game state (s1) to a second game state (s2). The series of inputs may comprise a series or sequence of button presses or other forms of input.

The user data module 118 is configured to store the user's history within the game provided by the computer generated gaming environment and to determine how often a user has encountered a specific game state. The user data module 118 can then be used to determine when the user encounters that game state and a message indicating that the game state has been encountered by that user can be transmitted to the user presence neural network module 108. Then, in a step S205, the user presence neural network module 108 determines how many times it has sampled the user encountering that game state.

If this is the first time the user is recorded as encountering this game state by the user data module 118 then this can be provided as a message to the user presence neural network module 108 in a step S206 to indicate the user has encountered this game state but the sample size on which the neural network is being trained is too small. Even if this is not the first time, but perhaps, the 10th time, a message may be provided to similarly indicate that the sample size corresponding to this user is below a sample threshold. Responsive to receiving this message, the user presence neural network module 108, in a step S206, provides an input (as part of the training phase) to the input layer 110 which is a randomly generated response action, i.e. a guess at what the user would have done in response to game state (s1) to the input layer 110. Then in a step S208, the response action which has been provided by the user in response to the game state, is retrieved from the user data module 118. The random generation of the response action may comprise sampling the response action (i.e. a series of inputs which could be provided by the user) from all of the possible combinations of inputs which could be provided as a response by the user to the first game state and providing the randomly generated response as an input in the training phase.

In a step S210, the randomly generated response action (which may be called the model response action) is compared to the response action (a1) which is provided by the user in response to encountering the first game state (s1). The comparison may take a very simple form. Each possible response action may be assigned an identifier and this is used to identify all response actions, both generated by the model and received from user data module 118. The comparison may therefore take the form of simply determining which identifiers correspond to the model response action and the user provided response action and then comparing the two to see if they are the same or not. The comparison may take a more complicated form in that the response action may be expressed as a vector of multiple variables. The comparison may compare the vectors to determine identity or none-identity.

If the model response action is identical to the response action provided by the user then a score associated with that response action (a1) in response to first game state (s1) is incremented by 1 and the scores associated with the other possible responses are decremented by one. This is step S212.

If the model response action is different from the response action provided by the user then a score associated with the model response action (a1) in response to the first game state (s1) is decremented by 1 and the score associated with the response action (a1) which was provided by the user is incremented by 1. This is step S214.

If the user has encountered the first game state more than a sample threshold determined number of times, i.e. more than 10, for example, then the user presence neural network module 108 may generate a response action (during the training phase) which is based on the data which it has already collected. In other words, the user presence neural network module 108 may select the response action (a1) which has been assigned the highest score during the initial phase of the training, i.e. when the sample size is less than or equal to the sample threshold, as an input to the input layer 112. This is step S216.

That is to say, after the sample threshold has been exceeded the training of the neural network provided by the user presence neural network module 108 can be based on inputs which are guided by what has been correct previously, i.e. the input (the model response action) which is used in the training is determined by the response action the user presence neural network module 108 has most frequently determined correctly to be the user's response to the first game state (s1).

In other words, the provided model response action is the response action which has been most frequently provided by the user previously. It is important to note that this may not be the optimal response action or the response action which enables progress in the game. Rather it is the response action which has been most often provided by that user.

The model response action provided by the user presence neural network module 108 is compared to the user response action (a1) which is detected by the user data module 118 when the user encounters the first game state (s1). This is step S218.

If the model response action is identical to the user response action then the score associated with the model response action is incremented by 1 and the score associated with all other possible response actions is decremented by 1. This is step S220.

If the model response action is distinct from the user response action then the score associated with the model response action is decremented by 1 and the score associated with the response action provided by the user, i.e. the user response action, is incremented by 1. This is step S222.

The process set out in steps S200 to S222 trains a neural network based on the response actions of a user who is playing a game inside a computer generated gaming environment provided by the cloud resource 104.

This process (i.e. steps S200 to S222) is repeated every time the user is detected as encountering the game state by the user data module 118 in step S205 and can be repeated for every game state in the game. The process detailed in steps S200 to S222 trains the neural network associated with the at least one user, i.e. the neural network initialised in step S200 is trained by this process.

The number of times the process detailed in steps S200 to S222 is repeated before training can be concluded can be specified by an operative of the system 100. It may be specified that the number is sufficient to minimise the statistical error to a small number (such as 10⁻⁵).

Alternatively or additionally, the model response action may be generated based on a response action provided by another member of the same user group when they encountered the same first game state. That is to say, during steps S206 or S216, a model response action which has scored highest during the training of a neural network associated with a member of the same user group may be provided as the model response action in the training of the neural network of a user in the same user group.

The user data module 118 can run after the training has concluded to monitor the selected user's actions inside the game (and monitor other users in the same user group). The data which is recorded after the training has concluded can then be used to update the training of the user presence neural network module 108 at regular intervals. This interval may be specified by a user of the first computing device 102 or any other operative of the system 100. This means the neural network provided by user presence neural network module 108 will be retrained to account for improvements in the user's competence in the game. Improvements in competence may be determined by the number of levels completed or any other quantifier which can determine progress in a game provided by the computing resource 104.

The results of the training are stored in appropriate storage, which may be local or remote relative to the cloud resource 104 or the user presence neural network module 108. The storage may include the date for each iteration of the training process for each game state. The storage may only include a game state with an identifier for the most frequently provided response action during the training phase.

The results of the training are used to optimise the policy function module 116. The use of the policy function module 116 to generate a user presence inside a computer generated gaming environment will be described below.

The policy function module 116 implements a policy function which predicts what response action the user (who is the subject of the training) would provide if they encountered a specific game state during their game play. Whilst the process described in relation to steps S200 to S222 is in respect of a first game state, it can be repeated for all game states which are encountered by that user.

If the selected user, i.e. the user who is the subject of the training process, is part of a larger user group then the training process set out in steps S200 to S222 may be repeated for all members of that user group. This will result in a neural network being trained for that user group. The user presence neural network module 108 may identify the user group autonomously. For example, when a user sets up a user profile in order to play the game in the computer generated gaming environment, they may enter specific details about themselves such as nationality or gender which would qualify that user as being part of specific demographic group. The user presence neural network module 108 may be configured to optimise the policy function module 116 for those users who fall within that specific demographic group. This would mean a policy function is configured for a specific demographic group. In another example, the user presence neural network module 108 may autonomously identify that the user of the first computing device 102 is associated with a group of other users by recording that they often play the game together. A policy function may then be optimised for that group of users. In another example, the user presence neural network module may optimise a policy function for all of the users who have ever played the game. This could be used to generate a user presence as described below which could be used to generate a generic other player as part of a single player mode.

The user presence neural network module 108 may optimise a policy function for a specific game state which may be called when the user (subject of the training) is playing the game and encounters the specific game state.

It should be made clear that when we say optimises the policy function for a group of users (even if the group includes a single user) we mean that the policy function provides an output to the output layer 114 which is a prediction of what a user who is representative of the user group (who are subject of the training) would provide. This may not be an optimal response for the game but simply the response action the user is expected to provide.

The policy function may be described as below:

$$π ( a 1 , s 1 ) = P r ( {a}_{t} = a 1 \vert {s}_{t} = s 1 )$$

Wherein Pr(aₜ=a1|sₜ=s1) maximises the reward associated with an action a1 in response to state s1. In other words, the output from the policy function is the most probable action a1 in response to state s1 by a user representative of the user group.

In practical terms, the policy function may be implemented by a lookup table which lists all of the game states encountered by the user group and the most likely response action to that game state by that user. As set out below, when a user presence is generated using the neural network implemented by user presence neural network module 108, the game state can be used as an input and the output, which will then be implemented in the computer generated gaming environment, will be the response action which scored highest during the training process and which will be selected by the optimised policy function. That is to say, in this example where there is a sample set of discrete possible response actions to a specific game state, the training process would enable a histogram of response actions to be formed for each game state for the selected user. At the culmination of the training phase, the optimal response action would be the one which has the highest score (i.e. the one which has been guessed correctly the most often during the training process), i.e. the column of the histogram which is highest.

In simple terms, the generated response action, i.e the response action which is predicted by the neural network, can then be provided to the cloud resource 104 using the user presence generation module and the response action generated by the user presence neural network module 108 can then be rendered in the computer generated gaming environment and thereby simulate the user on which the neural network is trained.

Alternatively or additionally, game states can be tagged according to the type of gaming scenario they represent. For example, one gaming scenario type may be used to tag a game state as a threat as it may be where a user encounters an enemy. Another gaming scenario type may be used to tag a game state as a high threat as it may be where a user encounters more than a single enemy at the same time. The space of all possible response actions may also be tagged according to the type of response which can be provided by the user. For example, a user may respond to a high threat game state with a first response action which could be tagged as aggressive (i.e. the response to the presence of multiple enemies could be to try to kill them all rather than retreating) where another user could respond with a second response action which could be tagged as less aggressive, i.e. first retreat then attack. The training process detailed in steps S200 to S222 may then be implemented to optimise the policy function based on gaming scenario types associated with game states. The policy function may then be used to predict response actions associated with a selected user for other games where scenarios are similarly tagged. This would make the user presence neural network module 108 backwards, forwards and sideways compatible in that it could be used to generate user presence in other games (i.e. games not part of the training process set out in steps S200 to S222) generated inside the computer generated gaming environment provided by the cloud resource 104. That is to say, the policy function could be optimised to be scenario specific rather than game specific.

We will now describe, with reference to FIG. 3, how the user presence neural network module 108 may be used to generate a user presence inside a computer generated gaming environment.

A first user of first computing device 102 may be using first computing device 102 to play a game inside a computer generated gaming environment provided by cloud resource 104. The user of first computing device 102 may desire to play the game against a friend. In a step S300, the user identifies the friend on a user interface as a player they wish to play. The cloud resource 104, having received a request from the user profile of the first computing device 102, may determine that the identified friend is not online at that time and so no gaming session can be initiated. This is step S302.

However, the cloud resource 104 may determine that it can access a neural network provided by user presence neural network module 108 which is associated with the identified friend, i.e. the user presence neural network module 108 has trained a neural network associated with the game play of the identified friend using the process detailed in steps S200 to S222. The neural network, provided with the game state as an input to the input layer 110, can use the policy function module 116 to predict the response which would be provided by the identified friend and this response can then be provided as a response action through output layer 114. The determination that such a neural network has been trained is step S304.

Responsive to the cloud resource 104 determining that this neural network can be accessed, a user interface can be provided on the first computing device 102 which prompts the user to indicate whether they would like to instead play with a computer generated version of their friend. That is to say, the user is prompted to ask if they would like a user presence generated in the computer generated gaming environment which will play like their friend. This is step S306.

On positive indication that the user of first computing device 102 would like to play with the user presence generated using the neural network trained on the gaming behaviour of their friend, the neural network which has been trained using steps S200 to S222 on their friend's responses to the game states in the game can be initialised. That is to say, the hardware and software resources which are necessary to pass inputs into the neural network and to receive outputs from the neural network are allocated and an application programming interface, for example, can be called to provide access to the trained neural network. This is step S308.

An avatar or other representation of the selected friend can then be rendered inside the computing generated gaming environment and which can then be visualised on the first computing device 102. The representation may be a game character in the game or it may be an avatar located on the user interface which graphically represents the friend. This is step S310. The gaming session involving the first user and a user presence corresponding to the selected friend can then be implemented on the first computing device 102. This is step S312, i.e. the gaming session between the user and the selected friend is initialised.

For the sake of simplicity and clarity, we describe the remaining steps with a specific example of a motor racing game where the first user and the user presence are racing against one another. This specific example is not intended to be limiting but is merely illustrative.

During the race between the first user and the generated user presence (i.e. the user presence which corresponds to the selected friend), the track comprises multiple bends and chicanes. In a first game state, the first user and the user presence approach a first bend. The possible response actions are numerous. The first user goes around the bend on the outside and so provides a series of inputs which causes their vehicle (i.e. the vehicle rendered in the game) to go around the outside of the bend. That is to say, the first user enters one possible sequence of inputs which constitutes their response action. This is step S314.

On determining that the generated user presence is encountering the first bend, the cloud resource 104 provides the game state (or an identifier corresponding to the game state) as an input to the input layer 110 of the neural network which is trained on the game play of the selected friend. This is step S316. That is to say, a message is passed from the user presence generation module 106 to the user presence neural network module 108 which comprises an identifier for the game state which the selected friend is encountering. Other metadata regarding the computer-implemented gaming session may also be provided as part of the message. Alternatively, an API call may be made which includes the identifier for the game state as a parameter.

The policy function module 116 then accesses the optimised policy function corresponding to the selected friend.

The optimised policy function then matches the identified game state to one on which it has been trained. That is to say, it may have been trained on that game state previously (i.e. when the friend corresponding to the generated user presence has been playing the motor racing game) and a response action can then be identified which corresponds to that game state. This response action can then be output as a response action indicative of what would be provided by the friend if they were playing the game. The identified response action will be the one which has scored highest during the training process in steps S200 to S222.

In the event that no training has been performed on that game state, the policy function module 116 may be configured to randomly generate a response action which will then be used as an identified response action. Alternatively or additionally, if the game states have been tagged, the policy function module 116 may identify a game state with a similar tag (i.e. another bend) and then generate a response action by selecting the response action which the policy function provides as the optimal response action for that game state, i.e. the response action the selected friend is likely to provide.

The response action identified in either event is then provided in a step S318. This response action is provided by the policy function module 116 based on the optimised policy function which is trained in steps S200 to S222, i.e. it provides the response action through output layer 114 and the response action is one which the friend corresponding to the user presence is likely to have provided (based on the training phase described in relation to steps S200 to S222).

The response action is then rendered in the computer generated gaming environment in step S320. For example, if the friend is likely to have responded to the bend by going around the inside of the bend rather than the outside, like the first user, this response action will be rendered inside the computer generated gaming environment.

For each game state encountered by the first user and the generated user presence, steps S316 to S320 can be repeated to generate a user presence in the computer generated gaming environment which is similar to the friend of the first user. That is to say, for each game state, a response action is generated by policy function module 116 which corresponds to the response action which is likely to have been provided by the friend if they were playing the game. This means that a user presence is generated which simulates the friend in the computer generated gaming environment. In other words, the user presence neural network module 108 receives an input indicative of the game state which is currently encountered by the friend and generates a response which the friend would likely have provided if they were playing the game.

Alternatively or additionally, rather than a selected friend, the first user may have indicated in step S300 that they wish to play against the world. In response to this, the response action which is provided in step S318 is provided based on a policy function which is trained (using steps S200 to S222) based on user data of all of the users who have played the game.

Alternatively or additionally, rather than a selected friend, the first user may identify a specific demographic group (e.g. those users who live in Coventry) and the response action which is provided in step S318 is provided based on a policy function which is trained based on user data of all users who, according to their user profiles, fall within the identified demographic group.

Alternatively or additionally, rather than a selected friend, the first user may identify that they wish to play against a famous personality. In the example of the motor racing game, this famous personality may a Formula One driver. That is to say, the response action which is provided in step S318 is provided based on a policy function based on that Formula One driver playing the game or a developer generating response actions during game development which are similar to that driver's style.

The method S300 to S320 shows how a neural network which is trained using a user's game play data can be used to simulate that user in the game play environment. This means that, if that user is not available to play the game, a player presence can be generated which plays like that user as the neural network will generate responses which would be expected of that user.

We will now describe, with reference to FIG. 4, how a non-player character (NPC) neural network module 120 can be used to configure the behaviour of an NPC inside a computer generated gaming environment, using user data from the user data module 118.

During a gaming session inside the computer generated gaming environment provided by cloud resource 104, the user will generate data about their own game play which can be used to optimise a policy function as set out above in respect of steps S200 to S222. This is step S400.

Additionally or alternatively to the training of such an optimised policy function for a user, another policy function can be trained to determine the behaviour of an NPC.

During the gaming session, at least one NPC will be initialised to interact with the player or players during the game play session. The presence of the NPC is generated by the NPC presence generation module 140 and it is rendered by the cloud resource in the computer generated gaming environment. The initialisation of the NPC means that its presence in the game is implemented by the cloud resource 104. An NPC may, for example, engage in battle with the player or may simply say something to the player. The actions of the NPC inside the computer generated gaming environment are determined by a non-player character policy function which is trained using the user data as we will now describe. The non-player character policy function is implemented by the NPC neural network module 120.

As the user of first computing device 102 (or any other player) engages with the game and encounters each of the game states of the game, their response actions are used to train a policy function associated with that user or user group. This is described above with respect to steps S200 to S222. Steps S300 to S320 are then used to generate a user presence inside the computer generated gaming environment which will respond to the game like that user would be expected to do.

The response actions of a player can also be used to similarly (to steps S200 to S222) train an NPC policy function for each NPC which is initialised within the game. This we will now be described.

On encountering a game state, a user of first computing device 102 will provide a response action as a series of inputs which will be interpreted by the cloud resource 104 and rendered within the game as a response action which will move the user from a first game state (s1) to a second game state (s2).

The NPC neural network module contains an input layer 122, a policy function layer 124 and an output layer 126. This is illustrated in FIG. 6.

The NPC neural network module 120 is configured to receive an indication that the user of first computing device 102 has encountered the first game state. This indication will come in the form of a message from the user data module 118. The message will comprise an identifier for the game state and an identifier for the response action provided by the user when they encounter the first game state. This is step S402. Alternatively or additionally, the NPC neural network module 120 may be configured to receive indications of any user (i.e. not just the user of the first computing device 102) encountering the first game state and carry out the steps of this method using that users responses to the game state.

The NPC neural network module 120 will use the first game state (or at least a numerical representation of the first game state) as an input to input layer 122 in addition to the response action provided in the message received in step S404.

The NPC neural network module 120 will then select from a number of possible NPC response actions as illustrated in FIG. 7.

As part of the coding of computer games, every single action which can be taken has a result which will transfer the player or NPC from the present game state to another game state. This is the case for every user and every NPC. Therefore each of the NPC response actions which can be provided by an NPC also results in a change in game state. In the example of a combat game, a the user of the first computing device 102 may initialise an attack on the NPC with a sword. The selection of the sword would be the response action to the first game state which is provided in step S404. During the training process, the NPC neural network module 120 will select from the NPC response actions.

One NPC response action is to put forward a shield which would block the sword, which would be another game state, which would require another response from the user of first computing device 102.

Another NPC response action is to do nothing, which would get the NPC killed by the sword carried by the user of the first computing device (or carried by the character represented by that player in the computer generated gaming environment), which would be another game state.

Another NPC response action is to respond with a sword, hence start a sword fight, which would be another game state. Each of the NPC response actions would lead to a second game state which would be respectively blocking the sword, getting killed or fighting with the sword.

In the initial part of the training phase, i.e. before a sampling threshold on the NPC training has been at least equalled, the response action is randomly selected by the NPC neural network module 120. This is step S406.

As set out above, each of the NPC response actions has a subsequent state change. For the NPC, its survival in the combat game is dependent on the selected response action. For example, if the response action is to do nothing in response to the user proffering a sword, then the NPC will be terminated. This change of game state will mean the game state changes to the user progressing past that enemy and the NPC dying. Each response action is therefore scored relative to the survival of the NPC. The NPC selecting a sword and proffering it in response to the user proffering their sword will result in a state change to survival (and awaiting a next action from the user). The NPC selecting a shield and blocking the sword will result in a state change to survival (and awaiting a next action from the user). The NPC doing nothing will result in the NPC dying (and the state change is the user progressing to a next game state and the NPC being killed). Each of the NPC response actions which result in survival are scored one point. The response action which results in death of the NPC is scored zero. That is to say, the response action is scored in a step S408 and it is scored based on how it maintains the presence of the NPC in the computer generated gaming environment. Steps S402 to S408 are repeated every time the user encounters the game state until the sampling threshold is equalled.

If the number of times the user has encountered this game state exceeds or equals a sampling threshold then the NPC neural network module 120 determines that it has sufficient data to generate a model response action based on the data it has already collected, rather than random selection as in step S406. The NPC neural network module 120 then generates a model response action by identifying the response action which has the highest score from previous iterations. This is step S414. That is to say, when the sampling threshold has been exceeded or equalled, the model response action is identified as the one which has the highest score attributed to it from the previous iterations of the user encountering this game state (during the training of the neural network). In simpler terms, in the example of a combat game, the model response action would be identified as the response action which has maintained the survival or progress of the NPC in previous iterations of that game state, i.e. the defensive actions rather than doing nothing.

The process described in relation to steps S402 to S414 are repeated for all game states encountered by the user. The policy function module 132 records the score for each NPC response action for each game state and, in doing so, records which NPC response action is most effective for each response action proffered by the user of first computing device 102.

The repetition of steps S402 to S414 can be repeated for all players who play the game. This trains the neural network which is initialised by the NPC neural network module 120. The scores for all players are then used to record scores against NPC response actions which are used by the policy function module 132 to determine which NPC response action is most effective.

The number of times the process detailed in steps S400 to S414 is repeated before training can be concluded can be specified by an operative of the system 100. It may be specified that the number is sufficient to minimise the statistical error to a small number (such as 10⁻⁵). Steps S400 to S414 can be repeated for all game states.

The training can be repeated at regular intervals to ensure the neural network provided by input layer 122, policy function layer 124 and output layer 126 is up to date with how users are playing the game.

The results of the training are stored in appropriate storage, which may be local or remote relative to the cloud resource 104 or the NPC presence generation module 120. The results of the training are used to optimise a policy function module 132 which is provided by policy function layer 124.

The policy function module 132 implements a policy function which determines the response action an NPC will provide if they encountered a specific user response action. The training of the policy function can be implemented for any subset of the users playing the game. The user data module 108 may determine, using game play statistics, that a subset of the game players are of a specific level of competence and the policy function may be designated accordingly. That is to say, a policy function may be trained for novice users, a different policy function may be trained for expert users.

The policy function may be described as below:

$$\begin{matrix}NPC ( a 1 , a 2 ) = PrNP C ( {a}_{NPC} = a 1 \vert {a}_{u s e r} = a 2 ) \\ Wherein \\ PrNP C ( {a}_{NPC} = a 1 \vert {a}_{u s e r} = a 2 )\end{matrix}$$

maximises the reward associated with an action a1 from an NPC in response to a response action a2 from a user. In other words, the output from the policy function PrNPC (a1|a2) is the most rewarding action for the NPC when a user takes action a2.

That is to say, the policy function provides the response action a1 which determines the response action an NPC should provide to a specific action from the user. By training the policy function on user data, the user's game play can determine how an NPC should behave inside the computer generated gaming environment. As the training of the policy function (i.e. the process detailed in steps S400 to S414) is trained using user data and the response actions are determined based on the optimal way for the NPC to proceed, the training process detailed in steps S400 to S414, in effect, teaches the NPC how to interact with the user, i.e. the person playing the game.

In practical terms, the policy function may be implemented by a lookup table which lists all of the response actions which are likely be encountered by an NPC and the most effective response action, i.e. the response action with the highest score.

In summary, steps S400 to S414 illustrate how a neural network can be used to teach an NPC how to react to a user in a game inside a computer generated gaming environment. Repeated training means that the neural network implemented by the NPC neural network module 120 improves as more and more users play the game and the NPC evolves and adapts as players become more competent.

The example described above very simple. That is an NPC which can respond to a user in one of three ways. It will be understood by the skilled person that the steps S400 to S414 may also apply to more complex combinations of actions from a user and larger selections of NPC response actions. That is to say, the simple example is for the purposes of a simple and clear explanation and should not be taken to be limiting.

We will now describe, with reference to FIG. 5, how the neural network provided by NPC neural network module 120 can be used to both determine and improve the interaction with an NPC by a user of first computing device 102.

In a gaming session, a user of first computing device 102 may encounter an NPC, the behaviour of which is determined by an in-game artificial intelligence 130 which is implemented by the neural network provided by NPC neural network module 120. This is step S500.

For the purposes of our example, we will describe the NPC as an enemy which the user of first computing device 102 must terminate before they can progress in the game.

In a step S502, the user of first computing device 102 draws their rifle from an assortment of weapons they have available to them. The cloud resource 104 has determined this is the response action from the user. This is input as a response action to the in-game artificial intelligence 130 which then issues a request to the NPC neural network module 120 for a response. This is step S504.

The NPC neural network module 120 uses the response action identifier (for the user drawing their rifle) as an input to the input layer 122. The input layer 122 may also receive metadata from the user data module 118 which may indicate that the user is a novice, for instance. The identifier and the quantifier indicating the user is a novice are then passed to the policy function layer 124 which uses the policy function module 132 to generate a response action for the NPC.

The policy function module 132 has been trained (in steps S400 to S414) to generate an NPC response action which is to hide as this is most likely to enable the NPC to survive in the game. Other choices are to run at the character controlled by the user, which will guarantee death of the NPC, or to pull a sword on the character controlled by the user, which will increase the likelihood of the death of the NPC as a single shot from the rifle will likely be more effective at terminating the NPC than a swipe of a sword.

During retraining, the optimal NPC response action may change. This may be because the users are becoming more competent in the game and they are choosing more effective weaponry.

The selected response action is then transmitted back to the in-game artificial intelligence which instructs the NPC presence generation module 120 to implement the NPC hiding as a response action.

The hiding of the NPC is then rendered in the computer generated gaming environment by the cloud resource 104. This is step S508.

The hiding of the NPC then triggers another response action from the user in response to the NPC response action. This response action is to put the rifle back into its holster and to select thermal imaging goggles to identify the enemy by the emission of their virtualised body heat. This is step S510. This selected response action is transmitted back to the in-game artificial intelligence 130 which requests a response from the NPC neural network module 120. This is step S512.

The response action from the user (i.e. the selection of thermal imaging goggles) is input into the input layer 122 with the identifier of the response action. Other metadata may also be input. Some of the metadata may be passed from the cloud resource 104 and it may relate to the computer generated environment. The metadata may, for example, indicate it is a nighttime scene and is dark. This is likely to make the NPC more visible on the thermal imaging goggles donned by the playing character.

Responsive to these parameters, the policy function module 132 may select a response which is to shoot the player played by the user. This is step S514. This is output back to the NPC presence generation module 120 by the output layer 126. This response is then implemented by the NPC presence generation module 120 which instructs the cloud resource 104 to render the NPC response action in the computer generated gaming environment. This is step S516. That is to say, the NPC then shoots the player character which is controlled by the first computing device 102. In the event where metadata indicates the user using the first computing device 102 may indicate the player is not a novice, the NPC response action may be changed to maintain a hiding place or to seek a more effective hiding place rather than shooting, as shooting can reveal their hiding place. This response action is indicated during training in steps S400 to S414 as optimal for more expert users as they are likely to select other, more effective equipment such as a grenade for instance.

That is to say, the policy function module 132 generates responses for the NPC based on training in steps S400 to S414 which indicate which response is optimal. The retraining of the neural network and the re-optimisation of the policy function which is provided by policy function module 132 improves the responses of the NPC. This is particularly effective for responding to evolving player behaviour and habits.

Steps S500 to S516 may be implemented similarly for all users in all game states and may also be implemented where the NPC is rendered in a multi-player environment. Input relating to all players can be used to generate an optimal response action for multiple players.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitable programmed computer. In a device claim enumerating several means, several these means may be embodied by one and the same item of hardware. The mere fact that certain measures are recited in mutually different dependent claims does not indicate that a combination of these measures cannot be used to advantage

1. A computer-implemented method of providing a first player presence in a computer generated gaming environment, the method implemented by a processing resource, the method comprising:
obtaining game play data associated with a second player presence in the computer generated gaming environment;
using the game play data associated with the second player presence to train a neural network associated with the second player presence;
providing the first player presence by:
determining a requirement for a response to a first game state provided in the computer generated gaming environment;
generating the response using the neural network associated with the second player presence.

2. A method according to claim 1, wherein the neural network associated with the second player presence is trained using reinforcement learning.

3. A method according to claim 2, wherein reinforcement learning is used to optimise a policy function configured to generated responses expected from the second player presence.

4. A method according to claim 1 wherein game play scenario characteristics are used to train the neural network.

5. A method according to claim 1 wherein the first player presence is a non-player character and the second player presence represents at least one user who controls or has previously controlled a character in the computer generated gaming environment.

6. A method according to claim 1 wherein the first player presence is provided responsive to a user encountering a first game state.

7. A method according to claim 1 wherein the first player presence is provided responsive to a request from a user with an active presence in the computer generated gaming environment.

8. A method according to claim 1 wherein the second player presence corresponds to at least one user of the computer generated gaming environment.

9. A method according to claim 1 wherein the second player presence corresponds to a group of users of the computer generated gaming environment.

10. A method according to claim 9 wherein the group of users are unified by a demographic characteristic.

11. A method according to claim 9 wherein the group of users are unified by a competence level in the computer generated gaming environment.

12. A method according to claim 1 wherein the training of the neural network is repeated at specified intervals.

13. A method according to claim 12 wherein the repetition of the training is initialised autonomously.

14. A method according to claim 1 wherein the gameplay data is associated with a response action to a game state.

15. A method according to claim 14 wherein the training is repeated for all game states which can be provided in the computer generated gaming environment.

16. A system for providing a first player presence in a computer generated gaming environment, comprising:
a memory comprising computer readable instructions; and
a processor configured to implement the method of claim 1.

17. A processing resource configured to implement the method of claim 1.

18. A non-transitory computer-readable storage medium comprising computer readable code to provide a first player presence in a computer generated gaming environment on a system which, when executed by a processing resource, causes the system to implement the method of claim 1.
